(19) United States
(12) Patent Application Publication
(10) Pub. No.: US 2008/0188241 A1
(43) Pub. Date: Aug. 7, 2008

(54) Alert Service Method For Specific Location Information of Mobile Terminal and Managing Apparatus and Mobile Terminal For the Same

(76) Inventors: Sung-Wook Mo, Gyeonggi-do (KR); Chul-Yong Park, Gyeonggi-do (KR)

Correspondence Address: JONES DAY, 222 EAST 41ST ST, NEW YORK, NY, 10017, US

(21) Appl. No.: 11/913,651

(22) PCT Filed: Sep. 29, 2006
(86) PCT No.: PCT/KR2006/003919

§ 371 Date: Nov. 5, 2007

(30) Foreign Application Priority Data
Oct. 1, 2005 (KR) 10-2005-0092647

(51) Int. Cl. H04Q 7/20

(52) U.S. Cl. 455/456.3

(57) ABSTRACT

An alert service method includes the steps of: receiving specific zone information and information of a target mobile terminal that is a target of alert setting; downloading an alert condition to the target mobile terminal, the alert condition being an alert generating condition for informing that the target mobile terminal goes into or out of the specific zone, the alert condition being determined as satisfied depending on a comparison result between an identifier of the specific zone and an identifier of a zone where the target mobile terminal is currently located; receiving a report message sent from the target mobile terminal when the alert condition is satisfied; and sending an alert message to a setting mobile terminal that is set to be informed of the alert.

### TECHNICAL FIELD

The present invention relates to an alert service method for specific location information of a mobile terminal, and a managing apparatus and a mobile terminal for the same, and more particularly to an alert service method for obtaining going-in or going-out information of a mobile terminal for a specific zone and informing another mobile terminal of the information, and a managing apparatus and a mobile terminal for the same.

### BACKGROUND ART

The alert service is a kind of value-added service informing a service demander that a specific mobile terminal goes into or out of a specific zone.

For the alert service, it is important to obtain location information of each base station cell for a mobile terminal that is a subject of alert. For this purpose, a method for periodically inquiring a location of a mobile terminal through a paging channel or a method for receiving an informing message from a mobile terminal when a cell ID is changed has been frequently used in the past.

However, in case of the alert service that periodically inquires a location of a mobile terminal through the paging channel, locations of numerous mobile terminals should periodically inquired, which may cause an overhead in a mobile communication network or a corresponding processing system. In addition, the alert service method receiving location information whenever a cell ID is changed should also process too many informing messages generated along with numerous moves of many mobile terminals between cells.

As an improvement of the alert service, Korean Laid-open Patent Publication No. 2004-16995, entitled “System for providing alert-based service to mobile stations in a wireless communication network”, discloses a technique for determining a fastest future time capable of satisfying an alert condition to obtain a location data, and Korean Patent Registration No. 490571, entitled “Location-based alert service method in a wireless communication environment”, discloses a technique for minimizing the number of location inquiries using a rate of moving distance of a mobile terminal or using a rate of area increase or decrease of MBR (Minimum Boundary Rectangle).

The above techniques are advantageous in the point that they may reduce the number of location inquiries for a mobile terminal rather than a conventional periodic inquiry method. However, the above techniques still suffer from serious loads applied to an alert service providing server or a mobile terminal since the alert service providing server makes repeated requests to the mobile terminal for obtaining location information and also the mobile terminal should manually give numerous answers correspondingly.

### DISCLOSURE OF INVENTION

### Technical Problem

The present invention is designed in consideration of the above problems, and therefore it is an object of the invention to provide an alert service method configured so that a mobile terminal itself checks an alert condition in order to reduce location inquiry traffics between a mobile communication network and the mobile terminal, and a managing apparatus and a mobile terminal for the same.

### Technical Solution

In order to accomplish the above object, the present invention executes the processes of downloading an alert condition to a specific mobile terminal, then receiving a report for alert occurrence from the mobile terminal when the mobile terminal goes into or out of a specific zone to satisfy the alert condition, and then informs the report message to another terminal.

That is to say, the present invention provides an alert service method includes (a) receiving specific zone information and information of a target mobile terminal that is a target of alert setting; (b) downloading an alert condition to the target mobile terminal, the alert condition being an alert generating condition for informing that the target mobile terminal goes into or out of the specific zone, the alert condition being determined as satisfied depending on a comparison result between an identifier of the specific zone and an identifier of a zone where the target mobile terminal is currently located; (c) receiving a report message sent from the target mobile terminal when the alert condition is satisfied; and (d) sending an alert message to a setting mobile terminal that is set to be informed of the alert.

In the step (a), the specific zone information and the information of the target mobile terminal are preferably input from the setting mobile terminal.

In the step (b), the identifier of the specific zone may be a base station cell ID, and the alert condition may be satisfied when a cell ID of the specific zone is identical to a base station cell ID where the target mobile terminal is current located.

As an alternative, it is also possible that the identifier of the specific zone is a base cell ID, and the alert condition is satisfied when a cell ID of the specific zone is different from a base station cell ID where the target mobile terminal is currently located.

In the step (c), the report message preferably includes MIN (Mobile Identification Number) of the target mobile terminal and the corresponding base station cell ID.

The report message may have a SMS (Short Message Service) message form or a cell RegNoti (Registration Notification) message form.

The alert condition may be downloaded at least one time point among when the mobile terminal powers on; when an execution environment for the mobile terminal to receive the alert condition is activated; and when the alert condition is changed.

In another aspect of the present invention, there is also provided an alert service managing apparatus, which includes a setting information receiving unit for receiving specific zone information and information of a target mobile terminal that is a target of alert setting; an alert condition providing unit for downloading an alert condition to the target mobile terminal, the alert condition being an alert generating condition for informing that the target mobile terminal goes into or out of the specific zone, the alert condition being determined as satisfied depending on a comparison result between an identifier of the specific zone and an identifier of a zone where the target mobile terminal is currently located; an alert receiving unit for receiving a report message sent from the target mobile terminal when the alert condition is satisfied; and an alert informing unit for sending an alert message to a setting mobile terminal that is set to be informed of the alert.

The report message may have a SMS message form.

As an alternative, the report message may also have a cell RegNoti message form.

The alert condition providing unit may download the alert condition at least one time point among when the mobile terminal powers on; when an execution environment for the mobile terminal to receive the alert condition is activated; and when the alert condition is changed.

In still another aspect of the present invention, there is also provided a recording medium loaded on and readable by an alert service managing apparatus connected to a mobile communication network, the recording medium comprising a program capable of executing: a process of receiving specific zone information and information of a target mobile terminal that is a target of alert setting; a process of downloading an alert condition to the target mobile terminal, the alert condition being an alert generating condition for informing that the target mobile terminal goes into or out of the specific zone, the alert condition being determined as satisfied depending on a comparison result between an identifier of the specific zone and an identifier of a zone where the target mobile terminal is currently located; a process of receiving a report message sent from the target mobile terminal when the alert condition is satisfied; and a process of sending an alert message to a setting mobile terminal that is set to be informed of the alert.

In further another aspect of the present invention, there is also provided a mobile terminal supporting alert service that informs another terminal that the mobile terminal goes into or out of a specific zone, the mobile terminal comprising: an alert condition receiving unit for receiving an alert condition from an alert service managing apparatus, the alert condition being determined as satisfied depending on a comparison result between a base station cell ID of the specific zone and a base station cell ID where the mobile terminal is currently located; a storing unit for storing the alert condition; a cell identifying unit for obtaining the base station cell ID where the mobile terminal is currently located; an alert checking unit for determining whether the base station cell ID obtained by the cell identifying unit satisfies the alert condition; and an alert reporting unit for generating a report message and sending the report message to the alert service managing apparatus in case the alert condition is satisfied.

The report message preferably includes MIN of the mobile terminal and the corresponding base station cell ID.

The report message may have a SMS message form or a cell RegNoti message form.

In still another aspect of the present invention, there is also provided a recording medium loaded on and readable by a mobile terminal supporting alert service that informs another terminal that the mobile terminal goes into or out of a specific zone, the recording medium comprising a program capable of executing: a process of receiving unit for receiving an alert condition from an alert service managing apparatus, the alert condition being determined as satisfied depending on a comparison result between a base station cell ID of the specific zone and a base station cell ID where the mobile terminal is currently located; a process of storing the alert condition; a process of obtaining the base station cell ID where the mobile terminal is currently located; a process of determining whether the base station cell ID obtained by the cell identifying unit satisfies the alert condition; and a process of generating a report message and sending the report message to the alert service managing apparatus in case the alert condition is satisfied.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 shows an alert service system according to a preferred embodiment of the present invention;

FIG. 2 is a block diagram showing function configurations of an alert service managing apparatus in FIG. 1;

FIG. 3 is a block diagram showing functional configurations of a mobile terminal in FIG. 1;

FIG. 4 is a flowchart illustrating the process of executing an alert service method according to a preferred embodiment of the present invention; and

FIG. 5 shows that a mobile terminal B goes into s a base station cell 1.

### DESCRIPTION OF REFERENCE NUMERALS IN THE DRAWINGS

100 . . . mobile terminal A 101 . . . mobile terminal B

150 . . . mobile communication network

200 . . . alert service managing apparatus

### BEST MODE FOR CARRYING OUT THE INVENTION

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

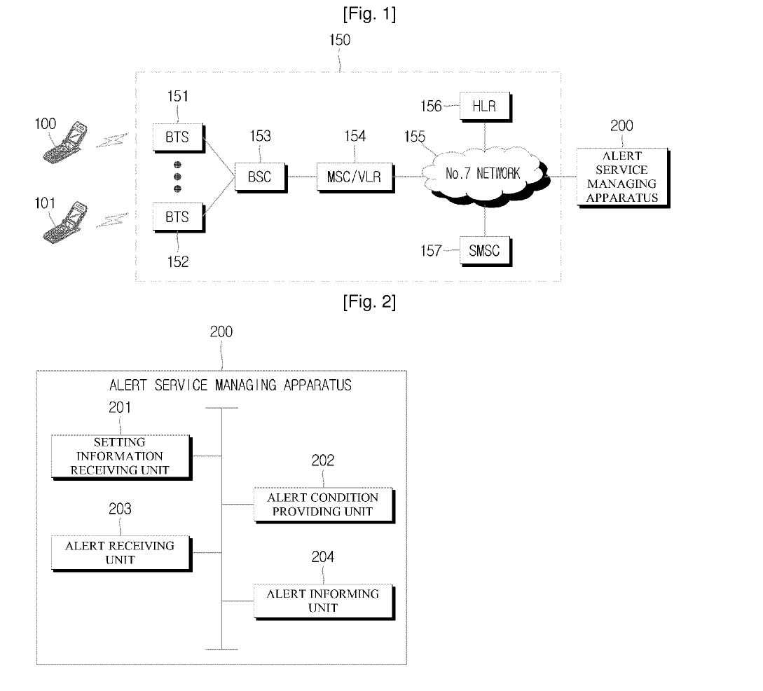

FIG. 1 shows an alert service system according to a preferred embodiment of the present invention.

Referring to FIG. 1, the alert service system of this embodiment includes an alert service managing apparatus 200 taking charges of overall data management and message sending for the alert service, an alert setting terminal (or, a setting mobile terminal) 100 connectable to the alert service managing apparatus 200 via a pre-determined network, an alert target terminal (or, an alert mobile terminal) 101 connectable to the alert service managing apparatus via a mobile communication network 150.

As shown in FIG. 2 in detail, the alert service managing apparatus 200 receives alert setting information, generates alert an condition, then downloads the alert condition to the alert target terminal 101, and informs a service demander of a message when an alert occurs. For this purpose, the alert service managing apparatus 200 includes a setting information receiving unit 201, an alert condition providing unit 202, an alert receiving unit 203, and an alert informing unit 204.

The setting information receiving unit 201 receives specific zone information and information of the alert target terminal 101, input by the service demander. Here, the service demander is preferably a user of the alert setting terminal 100, but it may also be a user of the alert target terminal 101. In the latter case, the service demander inputs specific zone information and information of his/her own mobile terminal (namely, the alert target mobile terminal 101) to the alert service managing apparatus 200 to request an alert service, and then, when an alert occurs, the alert service managing apparatus 200 sends an alert message to the alert setting terminal 100.

The alert setting terminal 100 is preferably a mobile terminal such as a cellular phone and PDA, but it may also us various communication devices capable of transmitting/receiving data in connection to the alert service managing apparatus 200 via a predetermined network, such as a personal computer (PC), not limited thereto. The alert setting terminal 100 and the alert target terminal 101 may have the same technical configuration, but hereinafter the alert setting terminal 100 is referred to as ‘mobile terminal A’ 100, and the alert target terminal 101 is referred to as ‘mobile terminal B’ 101, for convenience.

The information of the mobile terminal B 101 received to the setting information receiving unit 201 may include a phone number, and the specific zone information may be a region name as an example.

The alert condition providing unit 202 generates an alert condition, namely an alert generating condition for informing that the mobile terminal B 101 goes into or out of the specific zone, based on the specific zone information and the information of the mobile terminal B 101 input to the setting information receiving unit 201, and then downloads the alert condition to the mobile terminal B 101.

Here, the alert condition may be downloaded when the mobile terminal powers on, when a predetermined execution environment for the mobile terminal to receive the alert condition is activated, or when the alert condition is changed according to a new alert condition setting.

The alert condition is satisfied according to a comparison result between an identifier of a specific zone input to the setting information receiving unit 201 and an identifier of a zone where the mobile terminal B 101 is currently located. More specifically, the alert condition may be satisfied when the mobile terminal B 101 goes into a specific zone so that a base station cell ID in which the mobile terminal B 101 is current located is identical to a cell ID of the specific zone. As an alternative, the alert condition may be satisfied when the mobile terminal B 101 goes out of a specific zone so that a base station cell ID where the mobile terminal B 101 is currently located is different from the cell ID of the specific zone.

The alert condition providing unit 202 preferably generates an alert condition message having factors such as MIN (Mobile Identification Number) for identifying the mobile terminal B 101 and a base station cell ID corresponding to a specific zone. For example, the alert condition message may be generated with the contents such as ‘an alert occurs when a mobile terminal having a phone number of 016-XXX/XXXX goes into a base station cell LS0092X 2xxx’.

The alert condition is downloaded to the mobile terminal B 101, and the mobile terminal B 101 checks whether a base station cell ID where the mobile terminal B 101 is currently located satisfies the alert condition.

The alert receiving unit 203 receives a report message sent from the mobile terminal B 101 when the alert condition is satisfied. At this time, the report message preferably includes MIN of the mobile terminal B 101 and the base station cell ID where the mobile terminal B 101 is currently located.

The report message may be sent in a SMS message form, which is processed by SMSC (Short Message Service Center) 157 connected to a No. 7 network 155 of the mobile communication network 150 to give a sent/received message storing and transmitting function and a network accessing function, so that it may be directly received to the alert receiving unit 203. As an alternative, the report message may be received to the alert receiving unit 203 in a cell RegNoti (Registration Notification) message form. In the latter case, the report message is transmitted to the alert receiving unit 203 via at least one of a BSC (Base Station Controller) 153, a MSC (Mobile Switching Center) 154 and a HLR (Home Location Register) 156 of the mobile communication 150. As well known in the art, the mobile communication network 150 includes BTS (Base Transceiver Station) 151, 152 corresponding to the mobile terminal A 100 and the mobile terminal B 101, BSC 153 for controlling allocated BTS 151, 152, MSC 154 provided with VLR (Visitor Location Register), and HLR 156 connected to the MSC 154 via the No. 7 network 155.

The alert informing unit 204 sends a predetermined alert message, informing of an occurrence of an alert state, to the mobile terminal A 100 when the alert receiving unit 203 receives a report message. Here, the alert message is preferably sent as a SMS message, but any solution capable of informing a service demander of the alert state may be used, not limited to the above.

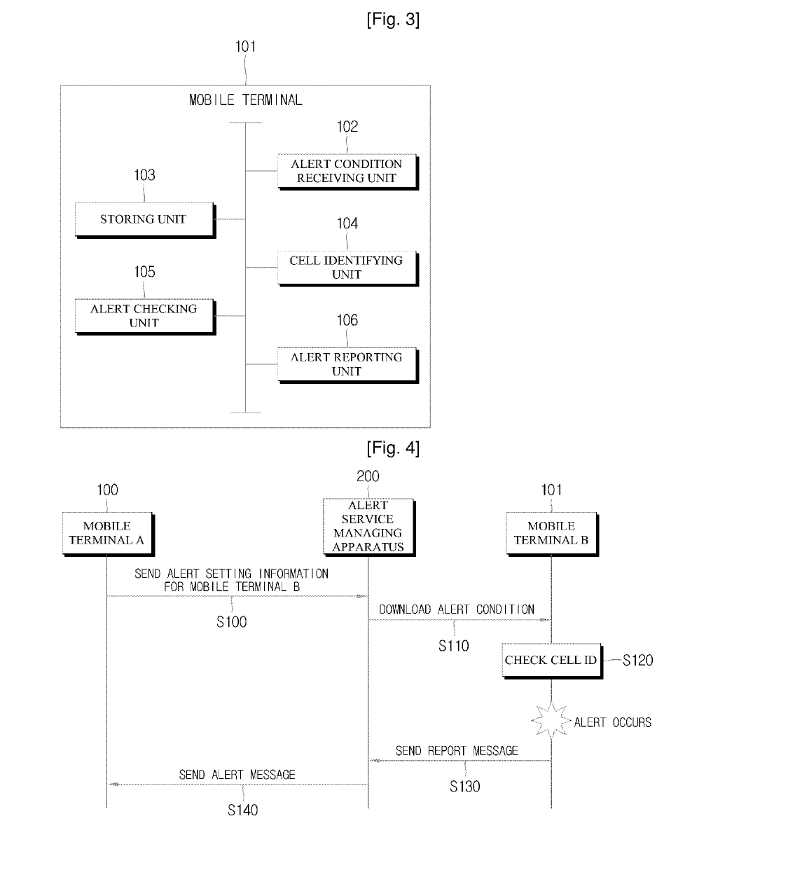

The mobile terminal B 101 shown in FIG. 3 in detail downloads and stores the alert condition provided from the alert service managing apparatus 200, then compares the alert condition with current location information to check whether the alert condition is satisfied, and reports an occurrence of an alert state to the alert service managing apparatus 200. For this purpose, the mobile terminal B 101 includes an alert condition receiving unit 102, a storing unit 103, a cell identifying unit 104, an alert checking unit 105, and an alert reporting unit 106.

The alert condition receiving unit 102 downloads the alert condition sent from the alert service managing apparatus 200, and the storing unit 103 stores the downloaded alert condition data to a predetermined memory area.

The cell identifying unit 104 obtains a base station cell ID in which the mobile terminal B 101 is currently located. That is, the cell identifying unit 104 analyzes a paging channel signal received at the current location with the strongest intensity to obtain the cell ID information, thereby allowing to identify a base station cell where the mobile terminal B 101 is currently located.

The alert checking unit 105 compares the cell ID obtained by the cell identifying unit 104 with a cell ID of the alert condition stored in the storing unit 103 so as to determine whether the alert condition is satisfied. Preferably, the alert checking unit 105 may be configured to conduct such comparing process whether a base station cell ID is changed.

In case the alert checking unit 105 determines that the cell ID currently belonging to the mobile terminal B 101 satisfies the alert condition, the alert reporting unit 106 generates a report message informing of the alert state and then sends the message to the alert service managing apparatus 200. At this time, the report message may be sent in a form of SMS message or a cell RegNoti message, as mentioned above.

Now, essential procedures of the alert service method executed by the alert service system according to the preferred embodiment of the present invention will be explained with reference to FIG. 4.

After an alert setting process in which a service demander sends specific zone information and information of the mobile terminal B 101 to the alert service managing apparatus 200 using the mobile terminal A 100 (S100), the alert service managing apparatus 200 receives the alert setting information, and then generates a corresponding alert condition message and downloads the message to the mobile terminal B 101 (S110).

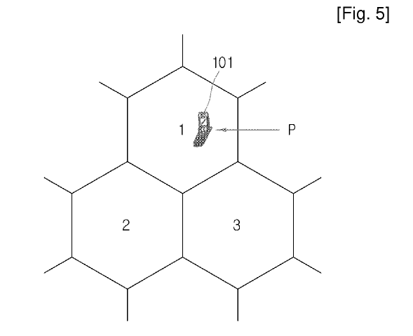

Here, it is possible to set the alert condition message to be satisfied when the mobile terminal B 101 goes into the base station cell 1 as shown in FIG. 5, as an example.

In addition, the alert condition is downloaded when the mobile terminal powers on, when a predetermined execution environment for the mobile terminal to receive the alert condition is activated (for example, a pop-up application explained later is executed), or when the alert condition is changed according to a new alert condition setting.

The mobile terminal B 101 continuously checks a base station cell ID where the mobile terminal B 101 is currently located, so as to determine whether the downloaded alert condition is satisfied (S120). Then, if the mobile terminal B 101 moves from a certain base station cell P to the cell 1 to satisfy the alert condition, the mobile terminal B 101 transmits a report message, informing of an occurrence of the alert, to the alert service managing apparatus 200 (S130). Here, the report message includes the MIN of the mobile terminal B 101 and the corresponding base station cell ID.

When receiving the report message from the mobile terminal B 101, the alert service managing apparatus 200 generates a corresponding alert message in a SMS form as an example, and then sends the alert message to the mobile terminal A 100 (S140). Accordingly, if the alert message is received to the mobile terminal A 100, the user of the mobile terminal A 100 recognizes that the user of the mobile terminal B 101 goes into the base station cell 1.

In the present invention as described above, the alert service managing apparatus 200 and the mobile terminal B 101 may have a recording medium (e.g., a flash memory) readable by a computer, which records a program for executing corresponding processes.

In particular, for the execution of the corresponding processes, the mobile terminal may be preferably provided with a mobile platform in a WIPI (Wireless Internet Platform for Interoperability) standard, an application program for obtaining a base station cell ID belonging to the mobile terminal to check whether the alert condition is satisfied and also providing a pop-up function for expressing the alert service related information, and an API (Application Program Interface) for interfacing between the mobile platform and the application program.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### INDUSTRIAL APPLICABILITY

According to the present invention, it is possible to prevent an overload applied to the alert service providing server or the mobile terminal since the alert service providing server does not need repeated requests for obtaining location information from a mobile terminal.

In addition, according to the present invention, a third party may easily recognize whether a mobile terminal goes into or out of a specific base station cell, so the present invention may be applied to protect or manage a specific person or a specific zone with a low cost.

1. An alert service method executed by an alert service managing apparatus connected to a mobile communication network, the method comprising:
(a) receiving specific zone information and information of a target mobile terminal that is a target of alert setting;
(b) downloading an alert condition to the target mobile terminal, the alert condition being an alert generating condition for informing that the target mobile terminal goes into or out of the specific zone, the alert condition being determined as satisfied depending on a comparison result between an identifier of the specific zone and an identifier of a zone where the target mobile terminal is currently located;
(c) receiving a report message sent from the target mobile terminal when the alert condition is satisfied; and
(d) sending an alert message to a setting mobile terminal that is set to be informed of the alert.

2. The alert service method according to claim 1,
wherein, in the step (a), the specific zone information and the information of the target mobile terminal are input from the setting mobile terminal.

3. The alert service method according to claim 1, in the step (b),
wherein the identifier of the specific zone is a base station cell ID, and
wherein the alert condition is satisfied when a cell ID of the specific zone is identical to a base station cell ID where the target mobile terminal is current located.

4. The alert service method according to claim 1, in the step (b),
wherein the identifier of the specific zone is a base cell ID, and
wherein the alert condition is satisfied when a cell ID of the specific zone is different from a base station cell ID where the target mobile terminal is currently located.

5. The alert service method according to 3 or 4,
wherein, in the step (c), the report message includes MIN (Mobile Identification Number) of the target mobile terminal and the corresponding base station cell ID.

6. The alert service method according to claim 5,
wherein the report message has a SMS (Short Message Service) message form.

7. The alert service method according to claim 5,
wherein the report message has a cell RegNoti (Registration Notification) message form.

8. The alert service method according to claim 1,
wherein, in the step (b), the alert condition is downloaded at least one time point among:
when the mobile terminal powers on;
when an execution environment for the mobile terminal to receive the alert condition is activated; and
when the alert condition is changed.

9. An alert service managing apparatus connected to a mobile communication network, comprising:
a setting information receiving unit for receiving specific zone information and information of a target mobile terminal that is a target of alert setting;
an alert condition providing unit for downloading an alert condition to the target mobile terminal, the alert condition being an alert generating condition for informing that the target mobile terminal goes into or out of the specific zone, the alert condition being determined as satisfied depending on a comparison result between an identifier of the specific zone and an identifier of a zone where the target mobile terminal is currently located;
an alert receiving unit for receiving a report message sent from the target mobile terminal when the alert condition is satisfied; and
an alert informing unit for sending an alert message to a setting mobile terminal that is set to be informed of the alert.

10. The alert service managing apparatus according to claim 9,
wherein the report message has a SMS message form.

11. The alert service managing apparatus according to claim 9,
wherein the report message has a cell RegNoti message form.

12. The alert service managing apparatus according to claim 9,
wherein the alert condition is downloaded at least one time point among:
when the mobile terminal powers on;
when an execution environment for the mobile terminal to receive the alert condition is activated; and
when the alert condition is changed.

13. A recording medium loaded on and readable by an alert service managing apparatus connected to a mobile communication network, the recording medium comprising a program capable of executing:
a process of receiving specific zone information and information of a target mobile terminal that is a target of alert setting;
a process of downloading an alert condition to the target mobile terminal, the alert condition being an alert generating condition for informing that the target mobile terminal goes into or out of the specific zone, the alert condition being determined as satisfied depending on a comparison result between an identifier of the specific zone and an identifier of a zone where the target mobile terminal is currently located;
a process of receiving a report message sent from the target mobile terminal when the alert condition is satisfied; and
a process of sending an alert message to a setting mobile terminal that is set to be informed of the alert.

14. A mobile terminal supporting alert service that informs another terminal that the mobile terminal goes into or out of a specific zone, the mobile terminal comprising:
an alert condition receiving unit for receiving an alert condition from an alert service managing apparatus, the alert condition being determined as satisfied depending on a comparison result between a base station cell ID of the specific zone and a base station cell ID where the mobile terminal is currently located;
a storing unit for storing the alert condition;
a cell identifying unit for obtaining the base station cell ID where the mobile terminal is currently located;
an alert checking unit for determining whether the base station cell ID obtained by the cell identifying unit satisfies the alert condition; and
an alert reporting unit for generating a report message and sending the report message to the alert service managing apparatus in case the alert condition is satisfied.

15. The mobile terminal according to claim 14,
wherein the report message includes MIN of the mobile terminal and the corresponding base station cell ID.

16. The mobile terminal according to claim 15,
wherein the report message has a SMS message form.

17. The mobile terminal according to claim 15,
wherein the report message has a cell RegNoti message form.

18. A recording medium loaded on and readable by a mobile terminal supporting alert service that informs another terminal that the mobile terminal goes into or out of a specific zone, the recording medium comprising a program capable of executing:
a process of receiving unit for receiving an alert condition from an alert service managing apparatus, the alert condition being determined as satisfied depending on a comparison result between a base station cell ID of the specific zone and a base station cell ID where the mobile terminal is currently located;
a process of storing the alert condition;
a process of obtaining the base station cell ID where the mobile terminal is currently located;
a process of determining whether the base station cell ID obtained by the cell identifying unit satisfies the alert condition; and
a process of generating a report message and sending the report message to the alert service managing apparatus in case the alert condition is satisfied.
